(19) United States
(12) Patent Application Publication
(10) Pub. No.: US 2008/0046220 A1
(43) Pub. Date: Feb. 21, 2008

(54) Autonomous Vehicle Chassis-Mast Attitude Emulator

(76) Inventors: David G. Fudala, Encinitas, CA (US); David S. Good, Escondido, CA (US)

Correspondence Address: STEVEN W. WEBB, 655 2ND STREET, ENCINITAS, CA, 92024, US

(21) Appl. No.: 11/738,684

(22) Filed: Apr. 23, 2007

Related U.S. Application Data
(60) Provisional application No. 60/838,820, filed on Aug. 21, 2006.

(51) Int. Cl. G01C 7/04

(52) U.S. Cl. 702/189

(57) ABSTRACT

A defined vehicle path emulator system is described, which system is used for measuring the (Fmin) specification for a path on a concrete floor traversed by a vehicle with a specific wheel base. The (Fmin) system is in use to locate and report the magnitude deviations away from zero planar infinity while traversing the path of a tall vehicle. This invention and system is distinct from the (FF/FL) measuring machines in the literature.

### RELATED U.S. APPLICATIONS

This application supplements and completes Provisional Application 60/838,820, filed Aug. 21, 2006.

### FIELD OF THE INVENTION

The present invention relates somewhat to the field of floor flatness, floor level measurement machines; explicitly, vehicle angle emulation and measurement. More particularly, the invention relates to a self-propelled, computer-driven, autonomous apparatus to imitate and measure the spatial orientation of a specific vehicle within a racking system, along a given floor path that which the specific vehicle traverses. The data output is pertinent for smoothing and leveling the surface for necessary compliance.

### BACKGROUND

The prior art within the literature does not contain autonomous measurement devices that roll incrementally or semi-continuously; however, they must roll at a constant velocity to avoid erroneous data sampling from unwanted accelerations and decelerations. This vehicle rolls semi-continuously and data is gathered at specific stopping points along a defined vehicle path. Furthermore, this invention performs angular chassis-mast emulation measurements exclusively in very narrow aisle warehouses for Minimum allowable chassis-mast attitude Fluctuation (F-min) with at least two separate profiles, collected perpendicular to each other concurrently, which are NOT indicative of the actual floor profile of the path measured as the prior art executes, but which pertain to the mast sway for a given vehicles wheel base. This output is completely different from the prior arts output listed below, which simply generates a single profile of a concrete slab—randomly placed anywhere—indicative simply of that line on the concrete floor where it was placed for an overall average Floor Flatness, Floor Levelness (FF/FL) number to asses the general characteristic of an entire floor area as a whole.

There are known manually-operated, rolling, measurement devices in the literature, including U.S. Pat. No. 5,859,783 to Face, et al. and U.S. Pat. No. 5,859,783 to Ytterberg, et al. These devices are used in association with the (FF/FL) system, to make several sets of parallel and perpendicular measurements of randomly-selected lines across an entire concrete slab to accomplish the average measurements of an entire area of a concrete pour or building, not a specific wheel path. Each of the prior patents above collects data similarly, but differently and the footprints of the measuring devices are approximately 1/16th-inch and 6-inches wide respectively. As will be shown, the prior art in the (FF/FL) measurement category are not direct antecedents to the present invention for many reasons as stated below.

The (FF/FL) machines in the prior art are not automated and self-directed, as is the present invention, and the second prior art listed is at best motorized. The (FF/FL) measurement are distinctly different from the mathematics used by the present invention, which measures a dual-axis quantity called (F-min) over a strictly-defined wheel path. (F-min) data is derived from the difference in elevations of points where specifically a vehicles wheels touch the surface independently for the transverse axis and articulated about the center of the transverse axis concerning the longitudinal component while driving or at rest with respect to the angle of the vehicle's chassis relationship triangulated through the vehicle's mast at height. In particular, the transverse measurement or crosswise tilt of the vehicle, perpendicular to the path of travel, is measured by evaluating the levelness between the left and right wheels (front or picking end) of the vehicle. The longitudinal measurement is derived similarly; yet differently, by measuring the levelness between the articulation point at the center of the transverse boom to the center of the articulation point on the rear axle or front-to-back of the vehicle (path of vehicle traversal) in the longitudinal direction. Both measurements of length for transverse and longitudinal wheel bases to compute (F-min) can vary on many different types of vehicles. Most vehicles wheel bases fall in the range of 32 to 62-inches for transverse and 60-to 186-inches for longitudinal.

The data is collected in a completely different manner for (FF/FL) devices; they must collect a single line of data with elevation points exactly 12-inches apart and only at 12-inch intervals by means of a single-axis frame, which produces a single two dimensional profile. The prior art machines listed above move at a constant speed and as their continuous data stream is sampled at intervals; they produce a profile. This profile is an elevation profile which starts with a distance of zero and the start point elevation is a know or unknown elevation above sea-level, and where each data point thereafter every 12-inches is fixed in space relative to each point before it, and fixed in space relative to the point that follows it, and so on until the end of that data line; hence, all points along the data line profile are related to one another, fixed in space, meaning a change in one elevation would affect all subsequent points that follow the changed elevation by the unit of change.

For the (F-min) measurements, which also start at a zero distance, there is no start point elevation that is plotted from the beginning like the prior art, nor is there a series of elevations relative to each other along a profile indicative of the floor surface data line measured like the prior art, and each point is not relative to the one before the present elevation like the prior art, nor is each elevation point relative to the elevation that follows like the prior art; conversely, the transverse elevation is solitarily relative to its co-linear opposite wheel elevation at each longitudinal distance location along the path; consequently, the data outcome is not affected by the elevation that follows, nor is it affected by the elevation that came before the current measurement like the prior art and, the longitudinal articulation elevation is solitarily relative to its co-linear opposite articulation elevation at the specific preset longitudinal distance location along the path; consequently, the data outcome is not affected by the elevation that will follow, nor was is affected by the elevation that came before the current measurement, and elevations are only relative to each other within the preset distance of the specific wheel base for the intended emulation; meaning a different wheel base configuration for a different vehicle will have a completely different set of profiles if the same path is measured again, unlike that of the prior art.

The transverse elevation measurement between wheels commences the preset distance ahead of the longitudinal boom length; hence, these profiles have different start points, and the longitudinal measurement between the articulation point of the transverse boom and the rear axle of the vehicle is the wheel base elevation measurement for the start point of that elevation and is spanned over the preset distance of the longitudinal boom length. So, (F-Min) is emulating the wheel base/mast correlation of a specific vehicle which has at least two profiles that are 90 degrees perpendicular to each other and that describe its side-to-side (transverse) and front-to-back (longitudinal) movements neither of which has any ties to elevation profiles along a complete line of data at a 12-inch distance interval, but where each elevation is only associated with corresponding wheel points within the wheel base of a given vehicle at that given location for a vehicle's overall length and width. This current invention's Memo Operand does not care if either end of a data line (floor) is higher or lower than the other end of the data line (floor) and if it is it will not indicate this; however, the output of the prior art does indicate this because it measures profile elevations along a data line, which is how they were designed to perform. Furthermore, Floor Flatness (FF) is calculated as the difference in elevation of consecutive 24-inch curvatures and Floor Levelness (FL) is calculated as the difference in elevation of consecutive 120-inch curvatures along the elevation profile of the 12-inch data point string. Again, the output of the prior art and this invention are not remotely similar.

An automated, self-propelled machine to carry out defined floor wheel path measurements along a designated line is desirable because of the need for machine-controlled precision to increase the number and quality of data points taken as accurately as possible within a micro-laser beam's width for the straightest of lines by keeping the invention in the exact wheel path of the future truck. The (FF/FL) measurement devices in the prior art are manually operated with human interference and employ only the minimum amount of motorization and cannot accomplish this task.

The present invention with its dual-axis configuration cannot be made to emulate or duplicate the performance of any of the prior art machines, and none of the prior art single-axis machines can be used to perform the process that the present invention automates.

The typical application of this invention is to measure the magnitude deviations away from zero planar infinity with regards to the absolute value of any given horizontal surface for a predefined vehicle path where surface levelness and profile slope-defects (rate-of-change within consecutive wheel base elevations) of specific wheel base spacing's are critical to the performance of automated warehouse equipment using that path, and the like. Magnitude deviations away from zero planar infinity will cause extreme adverse behavior by such equipment specified to operate within critical tolerance conditions; including collisions, causing spillage, undue stress on equipment, wear and tear on the floor system itself and last but not least severe injury to the human operator.

Floors so measured will be revisited using data output (e.g. charts, graphs) generated by the proprietary software in the invention's on-board computer system. Once completed surfaces can be analyzed and corrected by remedial measures if considered necessary.

### SUMMARY OF THE INVENTION

The present invention solves the prior art problems discussed above and provides a distinct advance in the state of the art regarding accuracy of the data collection process and straight line tracking. The present invention employs a wheeled platform with laser-detector guidance tracking system to roll true to a floor path designated by the user. The present invention measures and emulates vehicle chassis performance in the form of vehicle wheel base elevation as, crosswise tilt, and lengthwise tilt of the wheel base configuration. The data is collected simultaneously and semi-continuously on the fly using an on-board laptop computer and all of these data are used to compute mast sway (static-lean). The apparatus provides real-time data for immediate remedial activity in specific vehicle path wheel locations if such remedial activity is desirable.

The preferred embodiment of the present invention includes a controller for operating a drive mechanism and motor that propels the measuring apparatus, and a plurality of sensors operated by the controller to measure longitudinal and transverse chassis angles of a given vehicle and triangulation algorithms are engaged to calculate the mast sway at variable heights. In the preferred embodiment, the invention measures wheel base elevations that will be seen by a vehicle via measuring wheel difference elevations with respect to the measuring apparatus in selectable increments along the surface of the floor. In another preferred aspect of the invention, the measuring apparatus emulates crosswise and lengthwise tilt along the length and width of a vehicle's wheel base on the floor only where the wheels touch in preselected increments.

### BRIEF DESCRIPTION OF THE DRAWINGS

FIG. 1 is a perspective view of the vehicle emulator

FIG. 2 is an overview block diagram of the control and data processing systems of the profiler;

FIG. 3 is an exploded view of the vehicle emulator;

### DETAILED DESCRIPTION

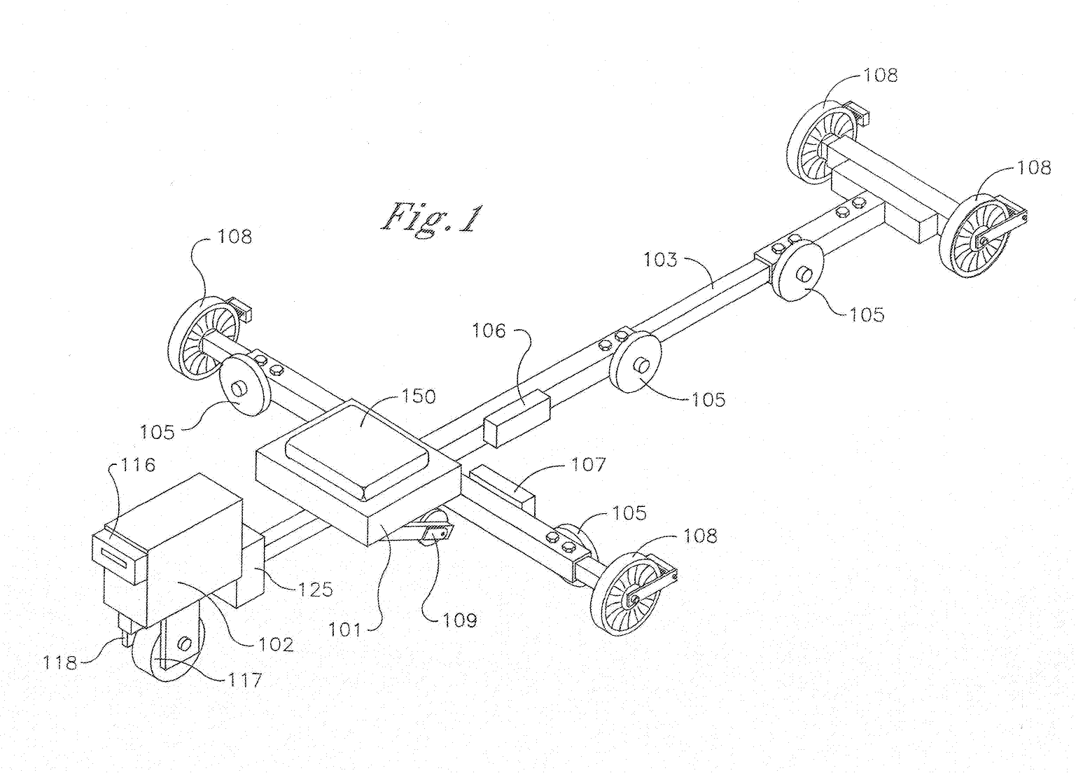

A preferred embodiment of the vehicle chassis emulator apparatus of the present invention, referred to as a vehicle emulator 100, is displayed in FIG. 1. The vehicle emulator 100 includes an electronics housing 101, drive wheel housing 102, longitudinal boom 103, transverse boom 104, a plurality of boom adjustment means 105, a longitudinal sensor 106, a transverse sensor 107, a plurality of boom wheels 108, a distance encoder wheel 109, a drive wheel 117, and a plurality of auto-marking pens 110 (not shown directly in the figure). A laptop computer 150 is placed physically on top of the vehicle emulator 100 and rides the vehicle emulator 100 during the vehicle emulation exercise.

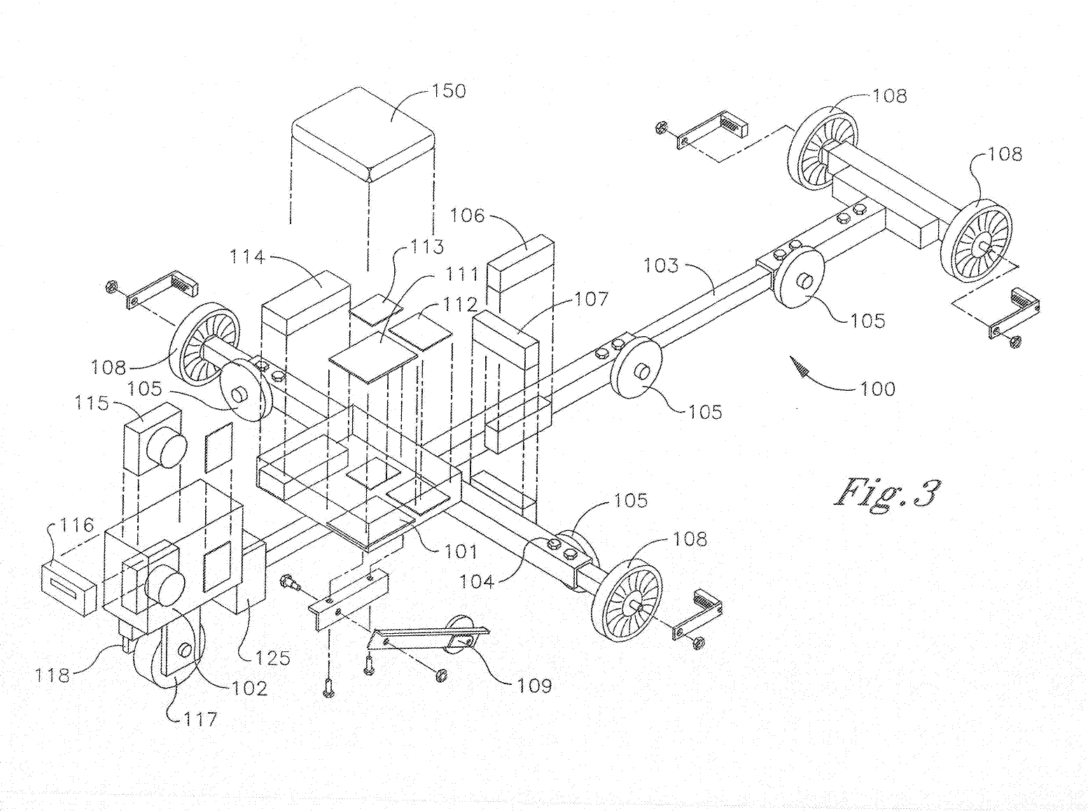

FIG. 3 shows the vehicle emulator 100 in an exploded view. As shown, within the electronics housing 101 are several subassemblies. The subassemblies are comprised of a profiler control circuit board 111, a signal conditioner circuit board 112, an auto-marking pens circuit board 113, and a battery 114.

The drive wheel housing 102 has within it a drive motor 115 and a steering servo 125 for the drive steering 117, which is electronically connected to the profiler guidance circuit board 118. The auto-marking pens 110 are placed under the booms where indicated and are pushed down to nearly encounter the floor and mark it with colored ink at the direction of the auto-marking pens circuit board 113.

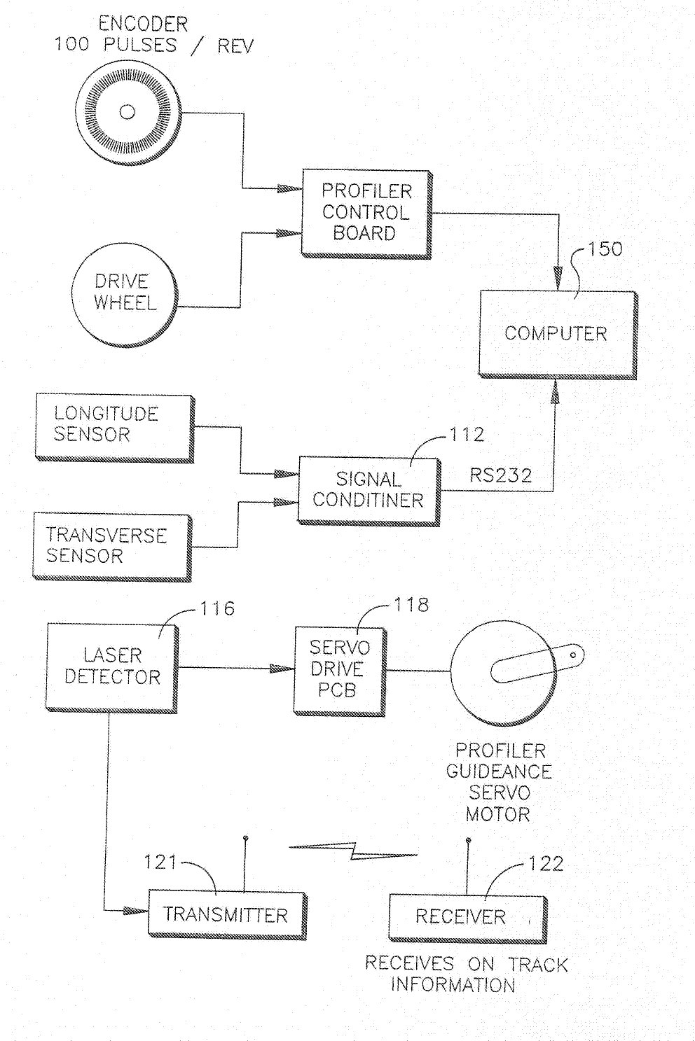

Referring to FIG. 2, the profiler guidance circuit board 118 controls the laser guidance feature of the preferred embodiment, receiving inputs from the laser detector 116 and sending commands to the profiler guidance PCB 118 and the profiler guidance servo motor 125.

The longitudinal sensor 106 and the transverse sensor 107 send outputs to an on-board signal conditioner 112, which is connected to the laptop computer 150 via an RS-232 serial/parallel port. The signal conditioner 112 communicates with the laptop computer 150 to inform the algorithms running on the laptop computer 150 of the status of the vehicle emulation exercise. The wheel base of the vehicle emulator 100 can be adjusted to meet the important parameters of the exercise.

The RS-232 parallel port communicates with the profiler control CB 111 which processes distance data from the encoder 109 for start and stop of the drive motor 115. Emulation distance is preset in the input parameters in the algorithms on board the computer 150.

The sensors 106, 107 are extremely receptive to any accelerations or decelerations. Therefore, the vehicle emulator 100 is stopped and stabilized before any readings are collected for superb accuracy and stored in the computer 150. The vehicle emulator 100 can be programmed to take all readings on-the-fly; but, with a reduction in measurement accuracy.

The vehicle emulator 100 is primarily an angle measurement device. Measurements are the difference between at least two points transversely and three or four points longitudinally. Readings are taken at intervals (distances entered into the onboard computer 150) while the emulator 100 has stopped and stabilized for accurate readings.

After storing the angle measurements, the profile 100 automatically moves the preset distance and takes the next angle measurement along with the distance measurement between readings, via the distance encoder 109.

Typically, using the preferred embodiment, the vehicle emulator 100 is tasked to emulate the track of a warehouse forklift truck. The floor condition of the aisles between the tall warehouse shelves directly impacts the performance of the truck. If the floor conditions are inferior to a pre-engineered limitation; the trucks cannot operate without causing collisions with the shelves at the top levels if that limitation is exceeded. That is, a small floor displacement (too high or too low) on one wheel of the truck results in an angular displacement from vertical for the trucks lifting mast. For a tall enough mast and narrow enough aisle, this can result in the top of the mast colliding with the shelves causing metal fatigue, uncontrollable oscillations and ultimately leading up to the failure of major structural components which is detrimental to a business and one's health.

The preferred embodiment of the present invention can emulate the wheel track any forklift truck by adjustment of the wheel base of the vehicle emulator 100. There are an infinite number of truck wheel profiles that can be emulated with the preferred embodiment.

The transverse boom 104 and longitudinal boom 103 can be adjusted with the boom adjustment means 105 to emulate the three or four wheels of the standard wheel trucks. The vehicle emulator 100 will navigate the project floor path between the future or existing racking and it will follow in the strict foot print of the wheels of the future or existing lift truck and the invention will record the deviation magnitude away from zero planar infinity for at least two perpendicular profiles. It will simultaneously mark the floor with the colored marking pens at the points where the deviations from specifications are sensed.

Input parameters entered into the laptop computer 150 include maximum tolerated deviations permissible, width of wheel base, length of wheel base, step size between measurements, and length of run. The laser guidance circuit board 111 will control the micro-steering servo 115 to minutely adjust the drive wheel 117 to track the vehicle emulator 100 in the center of the warehouse aisle path. The laser detector 116 is in the preferred embodiment as a set of photodiodes placed in a horizontal array that measures deviation from the center null point of the laser pulse.

The vehicle emulator 100 is actually an autonomous robot once it has been activated by commands from the laptop computer 150 and no human intervention is needed other than to stop the vehicle emulator. The laptop computer 150 records the sensor data from the sensors 106, 107 continuously and the sensors 106, 107 via the sensor circuit board 112 control individual marking pens for out-of-tolerance anomalies 110.

The laptop computer orders the vehicle emulator 100 to move from point to point by means of commands to the drive motor/transmission 115. The run can be interrupted (paused) by means of commands entered at the laptop computer 150, and then restarted. The laser guidance circuit board 111 only directs the angle at which the drive wheel 117 operates, thereby steering the vehicle emulator 100 down the aisle literally in a line as straight as the laser beam with unnoticeable side-to-side movement.

In FIG. 2, the transmitter 121 sends a signal to a remote receiver 122 when the laser detector senses that the laser beam is centered and simultaneously a solid “beep” tone is sounded. An operator can leave the autonomous profiler once it has been started, and will be warned remotely by the receiver 121 if the profiler goes off course by the cessation of the beep tone.

Although the invention has been described as a preferred embodiment, equivalent features may be employed and substitutions made within this specification without departing from the scope of the invention as recited in the claims.

What is claimed is:

1. a vehicle path emulator, the vehicle path emulator comprised of a longitudinal boom, a long transverse boom (front axle), and a short transverse boom (rear axle)
the short transverse boom placed orthogonally at the rear of the longitudinal boom, the long transverse boom placed orthogonally at the front of the longitudinal boom, the short and long transverse booms each terminating in wheels,
the longitudinal (front-to-back) boom possessing a longitudinal sensor, the longitudinal boom also possessing a plurality of auto-marking pens,
the transverse (side-to-side) boom possessing a drive wheel housing at one end, an electronics housing on top, a laptop computer on top of the electronics housing, a transverse sensor, and a distance encoder wheel,
the drive wheel housing possessing a drive wheel, a drive motor, and a steering servo, the drive wheel housing having attached to it a guidance system,
the guidance system comprised of a beam emitter and a beam receiver,
the electronics housing containing a profiler control circuit board, a signal conditioner circuit board, an auto-marking pens circuit board, and a battery.
the longitudinal boom and short and long transverse booms also each possessing a plurality of boom adjustment means.

2. The method of measuring a defined vehicle path comprised of the steps of
obtaining the vehicle parameters of the specific vehicle to be emulated,
adjusting the length of the transverse boom to meet the vehicle wheel width parameters,
adjusting the length of the longitudinal boom to meet the vehicle wheel base length parameters,
calibrating the electronic sensors of the emulator, zeroing the electronic sensors of the emulator,
placing the vehicle path emulator at the start of the path to be emulated,
setting the plurality of marking pens such that they nearly contact the floor,
aiming the beam emitter down the center of the designated path,
setting the beam receiver such that it senses the beam,
entering the measurement distance interval into the laptop computer,
entering the pre-engineered levelness parameters for the specific vehicle that is to be emulated into the laptop computer,
starting the emulation by means of a command entered at the laptop computer,
monitoring the progress of the vehicle path emulator by means of audible signals emitted by the guidance system,
stopping the emulation by means of commands entered at the laptop computer,
analyzing the data recorded on the laptop computer by means of the installed proprietary software output in the form of color charts and graphs,
analyzing the delineations on the floor from the auto-marking pens while correlating them to the out-of-tolerance anomalies on the charts if applicable.
